(19) United States
(12) Patent Application Publication
(10) Pub. No.: US 2011/0088591 A1
(43) Pub. Date: Apr. 21, 2011

(54) INKJET INK SET

(75) Inventors: Michael Stephen Wolfe, Wilmington, DE (US); Nathaniel Reed Schwartz, Newark, DE (US)

(73) Assignee: E.I. DU PONT DE NEMOURS AND COMPANY, Wilmington, DE (US)

(21) Appl. No.: 12/993,879

(22) PCT Filed: Jun. 25, 2009
(86) PCT No.: PCT/US2009/048669

§ 371 Date: Nov. 22, 2010

Related U.S. Application Data
(60) Provisional application No. 61/133,386, filed on Jun. 26, 2008.

(51) Int. Cl. C09D 11/02; C09D 11/10

(52) U.S. Cl. 106/31.65; 524/1

(57) ABSTRACT

The present invention pertains to an inkjet ink set comprising a certain aqueous, pigmented magenta inkjet ink in combination with a certain aqueous, pigmented yellow inkjet ink or a fixer ink. The pigmented magenta ink comprises Pigment Red 146 with defined particle sizes.

### CROSS REFERENCE TO RELATED APPLICATIONS

This application claims priority under 35 U.S.C. §119 from U.S. Provisional Application Ser. No. 61/133,386, filed Jun. 26, 2008.

### BACKGROUND OF THE INVENTION

Inkjet printing is a non-impact printing process in which droplets of ink are deposited on a substrate, such as paper, to form the desired image. Inkjet printers are equipped with an ink set which, for full color printing, typically comprises a cyan, magenta and yellow ink (CMY). An ink set also commonly comprises a black ink (CMYK). Colorants for the inks may be soluble in the ink vehicle (such as dyes) or insoluble (such as pigments).

Pigment Red 122 (PR122) is the most often used magenta pigment colorant. Pigmented inkjet ink sets comprising Pigment Red 122 as the magenta colorant are disclosed, for example, in U.S. Pat. Nos. 5,085,698; 5,738,716; 6,153,000 and 6,395,079. An improved magenta pigment colorant should compare favorably with PR122 in terms of optical density and chroma. While various known magenta inkjet ink colorants, both pigment and dye, provide printed images having good color characteristics, a need still exists for alternative colorants with higher optical density, chroma and/or lower cost. The present invention satisfies this need by providing compositions of an inkjet ink set comprising a certain aqueous pigmented magenta inkjet ink and a certain aqueous pigmented yellow inkjet ink, or a fixer ink, having improved optical density, chroma, hue and cost.

### SUMMARY OF THE INVENTION

An embodiment of the invention provides an inkjet ink set comprising a first ink and a second ink, wherein said first ink comprises an aqueous vehicle and particles of Pigment Red 146 (PR146) dispersed in the aqueous vehicle, wherein the particles of PR146 collectively comprise a distribution of particle sizes, and wherein the volume median particle diameter (D50) of the distribution of particle sizes for PR146 is greater than 120 nm as measured by laser diffraction techniques; and said second ink comprises an aqueous vehicle and Pigment Yellow 74 (PY74) or a fixing agent capable of fixing the first ink.

Another embodiment provides that the D50 of the distribution of particle sizes for PR146 is greater than 125 nm and the volume diameter of the 95^{th} percentile (D95) of the distribution of particle sizes for PR146 is less than 375 nm.

Another embodiment provides that the D50 of the distribution of particle sizes for PR146 is in the range of 130 to 170 nm, and the D95 of the distribution of particle sizes for PR146 is less than 325 nm.

Another embodiment provides that the second ink comprises Pigment Yellow 74.

Another embodiment provides that the second ink comprises a fixing agent capable of fixing the first ink.

Another embodiment provides that the particles of Pigment Red 146 in the first ink are dispersed in the aqueous vehicle with an anionic polymeric dispersant.

Yet another embodiment provides that the first and second inks each individually has a surface tension in the range of about 20 mN·m⁻¹ to about 50 mN·m⁻¹ at 25° C., and a viscosity in the range of about 1 mPa·s to about 20 mPa·s at 25° C.

The pigment names and abbreviations used herein are the “C.I.” designation for the pigment established by Society Dyers and Colourists, Bradford, Yorkshire, UK and published in The Color Index, Third Edition, 1971.

These and other features and advantages of the present invention will be more readily understood by those of ordinary skill in the art from a reading of the following Detailed Description. Certain features of the invention which are, for clarity, described above and below as a separate embodiment, may also be provided in combination in a single embodiment. Conversely, various features of the invention that are described in the context of a single embodiment, may also be provided separately or in any subcombination.

### DETAILED DESCRIPTION

Unless otherwise stated or defined, all technical and scientific terms used herein have commonly understood meanings by one of ordinary skill in the art to which this invention pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

As used herein, reference to enhanced or improved “print quality” means some aspect of optical density, gloss, and Distinctness of Image (DOI) of the printed images and fastness (resistance to ink removal from the printed image) is increased, including, for example, rub fastness (finger rub), water fastness (water drop) and smear fastness (highlighter pen stroke).

As used herein, the term “SDP” means a “self-dispersible” or “self-dispersing” pigment.

As used herein, the term “dispersion” means a two phase system wherein one phase consists of finely divided particles (often in a colloidal size range) distributed throughout a bulk substance, the particles being the dispersed or internal phase and the bulk substance being the continuous or external phase.

As used herein, the term “dispersant” means a surface active agent added to a suspending medium to promote uniform and maximum separation of extremely fine solid particles often of colloidal sizes. For pigments other than self-dispersing pigments, the dispersants are most often polymeric dispersants, and the dispersants and pigments are usually combined using a dispersing equipment.

As used herein, the term “OD” means optical density.

As used herein, the term “Gloss” means observation of reflected light from a printed surface, normally the printed substrate is glossy paper

As used herein, the term “aqueous vehicle” refers to water or a mixture of water and at least one water-soluble organic solvent (co-solvent).

As used herein, the term “ionizable groups” means molecular moieties that have the potential to become ionic under certain conditions.

As used herein, the term “substantially” means being of considerable degree, almost all.

As used herein, the term “jetability” means good jetting properties with no clogging or deflection during printing.

As used herein, the term “Mn” means number average molecular weight.

As used herein, the term “D50” means the volume particle diameter of the 50th percentile (median) of the distribution of particle sizes.

As used herein, the term ‘D95’ means the volume particle diameter of the 95th percentile of the distribution of particle sizes.

As used herein, the term “psi” means pound per square inch, a pressure unit.

As used herein, the term “cP” means centipoise, a viscosity unit.

As used herein, the term “mPa·s” means millipascal second, a viscosity unit.

As used herein, the term “mN·m⁻¹” means milliNewtons per meter, a surface tension unit.

As used herein, the term “EDTA” means ethylenediaminetetraacetic acid.

As used herein, the term “IDA” means iminodiacetic acid.

As used herein, the term “EDDHA” means ethylenediamine-di(o-hydroxyphenylacetic acid).

As used herein, the term “NTA” means nitrilotriacetic acid.

As used herein, the term “DHEG” means dihydroxyethylglycine.

As used herein, the term “CyDTA” means trans-1,2-cyclohexanediaminetetraacetic acid.

As used herein, the term “DTPA” means dethylenetriamine-N,N,N′,N″,N″-pentaacetic acid.

As used herein, the term “GEDTA” means glycoletherdiamine-N,N,N′,N′-tetraacetic acid.

As used herein, Surfynol® 465 is a surfactant commercially available from Air Products (Allentown, Pa., U.S.A.).

As used herein, Glycereth-26 is the polyethylene glycol ether of Glycerin with an average ethoxylation value of 26.

As used herein, Proxel™ GXL is a Biocide commercially available from Avecia (Wilmington, Del., U.S.A.).

Unless otherwise noted, the above chemicals were obtained from Aldrich (Milwaukee, Wis., U.S.A.) or other similar suppliers of laboratory chemicals.

The materials, methods, and examples herein are illustrative only except as explicitly stated, and are not intended to be limiting.

In addition, references in the singular may also include the plural (for example, “a” and “an” may refer to one, or one or more) unless the context specifically states otherwise.

### Pigments

The raw pigments are insoluble and non-dispersible in the ink vehicle and must be treated in order to form a stable dispersion. “A stable dispersion” means that the pigment is finely divided, uniformly distributed and resistant to particle growth and flocculation.

Treatment of a pigment with a dispersant can stabilize the pigment by forming a dispersion. The term “dispersant” as used herein is generally synonymous with the terms “dispersing agent” and “suspending agent” which are also found in the art.

The dispersant can be any suitable dispersant such as, for example, those disclosed in U.S. Pat. Nos. 4,597,794; 5,085,698; 5,519,085 and 6,143,807, and U.S. Patent Publication. No. US2008/0071007.

A dispersion is prepared by premixing a pigment and a dispersant, followed by dispersing or deflocculating the mixture in a milling step. The premixture includes an aqueous carrier medium (such as water and, optionally, a water-miscible solvent) when the milling step involves a wet milling operation. The milling step may be accomplished in a 2-roll mill, media mill, a horizontal mini mill, a ball mill, an attritor, or by passing an aqueous premix through a plurality of nozzles within a liquid jet interaction chamber at a liquid pressure of at least 5,000 psi to produce a uniform dispersion of the pigment particles in the aqueous carrier medium (microfluidizer). Alternatively, the concentrates may be prepared by dry milling the dispersant and the pigment under pressure. The media for the media mill is chosen from commonly available media, including zirconia, YTZ® (Nikkato Corporation, Osaka, Japan), and nylon. These various dispersion processes are in a general sense well-known in the art, as exemplified by U.S. Pat. Nos. 5,022,592; 5,026,427; 5,310,778; 5,891,231; 5,679,138 and 5,976,232, and U.S. Patent Publication No. 2003/0089277. The pigment dispersion is typically made in a concentrated form (dispersion concentrate), which is subsequently diluted with a suitable liquid containing the desired additives to form the final ink.

It may also be possible to make one or more of the pigments into a so-called self-dispersing pigment. The term self-dispersing pigment (“SDP”) refers to pigment particles whose surface has been chemically modified with hydrophilic dispersibility-imparting groups that allow stable dispersion in an aqueous vehicle without a separate dispersant. The hydrophilic dispersibility-imparting surface groups are typically ionizable.

An SDP may be prepared by grafting a functional group or a molecule containing a functional group onto the surface of the pigment, by physical treatment (such as vacuum plasma), or by chemical treatment (for example, oxidation with ozone, hypochlorous acid or the like). A single type or a plurality of types of hydrophilic functional groups may be bonded to one pigment particle. The hydrophilic groups are carboxylate or sulfonate groups which provide the SDP with a negative charge when dispersed in aqueous vehicle. The carboxylate or sulfonate groups are usually associated with monovalent and/or divalent cationic counter-ions. Methods of making SDPs are well known and can be found, for example, in U.S. Pat. No. 5,554,739 and U.S. Pat. No. 6,852,156.

The “colorant content” in a given ink refers the total colorant present in that ink, whether a single colorant species or a combination of two or more colorant species.

As specified in the present invention, the distribution of PR146 particles in the ink have a volume median diameter (D50) greater than about 120 nm and typically greater than 125 nm. In one embodiment, the D50 is in the range of 130 to 170 nm. In another embodiment, the D95 of the PR146 particle distribution is less than 375 nm specifically less than 325 nm.

The particle size values of the dispersion are based on values measured by laser diffraction methods compliant with ISO 13320-1 Particle size analysis—laser diffraction methods (International Organization for Standardization). Commercial equipment for such measurement includes a Microtrac Particle Size Analyzer manufactured by Microtrac Inc., Montgomeryville, Pa., USA. A description of laser diffraction methodology can be found, for example, in Particle Size Measurement Chapter 14, 3rd edition, Terence Allen, Chapman and Hall, 1981.

The prescribed Pigment Red 146 and Pigment Yellow 74 colorants are commercially available from various vendors including, for example, Clariant Pigments and Additives, Coventry, R.I., USA. However, to achieve the specified particle size of PR146, not all grades of the pigment may be suitable and some routine optimization may be required to ensure that a given pigment grade will reliably yield the required particle size. Such optimization is well within the abilities of one ordinarily skilled in the art.

### Vehicle

Selection of a suitable aqueous vehicle mixture depends on requirements of the specific application, such as the desired surface tension and viscosity, the selected colorant, drying time of the ink, and the type of substrate onto which the ink will be printed. Representative examples of water-soluble organic solvents which may be utilized in the present invention are those that are disclosed in U.S. Pat. No. 5,085,698.

If a mixture of water and a water-soluble solvent is used, the aqueous vehicle typically will contain about 30% to about 95% of water with the remaining balance (i.e., about 70% to about 5%) being the water-soluble solvent. Compositions of the present invention may contain about 60% to about 95% of water, based on the total weight of the aqueous vehicle.

The amount of aqueous vehicle in the ink is typically in the range of about 70 to about 99.8%; specifically about 80% to about 99.8%, based on total weight of the ink.

The aqueous vehicle can be made to be fast penetrating (rapid drying) by including surfactants or penetrating agents such as glycol ether(s) or 1,2-alkanediols. Suitable surfactants include ethoxylated acetylene diols (e.g., Surfynols® series commercially available from Air Products), ethoxylated primary (e.g., Neodol® series commercially available from Shell) and secondary (e.g., Tergitol® series commercially available from Union Carbide) alcohols, sulfosuccinates (e.g., Aerosol® series from Cytec), organosilicones (e.g., Silwet® series from Witco) and fluoro surfactants (e.g., Zonyl® series commercially available from DuPont).

The amount of glycol ether(s) or 1,2-alkanediol(s) added must be properly determined, but is typically in a range of from about 1% to about 15% by weight, and more typically about 2% to about 10% by weight, based on the total weight of the ink. Surfactants may be used, typically in an amount of about 0.01% to about 5%, and specifically from about 0.2% to about 2%, based on the total weight of the ink.

### Additives

Other ingredients, additives, may be formulated into the inkjet ink, to the extent that such other ingredients do not interfere with the stability and jetability of the inkjet ink. This may be readily determined by routine experimentation by one skilled in the art.

Surfactants are commonly added to inks to adjust surface tension and wetting properties. Suitable surfactants include the ones disclosed in the “Vehicle” section above. Surfactants are typically used in amounts up to about 5% and more typically in amounts up to 2% by weight, based on the total weight of the ink.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Polymers may be added to the ink to improve durability or other properties. The polymers can be soluble in the vehicle or in a dispersed form, and can be ionic or non-ionic. Soluble polymers include linear homopolymers and copolymers or block polymers. They can also be structured polymers including graft or branched polymers, stars and dendrimers. The dispersed polymers may include, for example, latexes and hydrosols. The polymers may be made by any known process including, but not limited to, free radical, group transfer, ionic, condensation and other types of polymerization. The polymers may be made by a solution, emulsion, or suspension polymerization process. Preferred classes of polymer additives include anionic acrylic, styrene-acrylic and polyurethane polymer.

When a polymer is present, the polymer level is typically between about 0.01% and about 3% by weight, based on the total weight of an ink. The upper limit is dictated by ink viscosity or other physical limitations.

Biocides may be added to inhibit growth of microorganisms. Buffers may be added to maintain pH.

### Proportions of Ingredients

The components described above can be combined to make an ink in various proportions and combinations in order to achieve the desired ink properties. Some experimentation may be necessary to optimize an ink for a particular end use, but such optimization is within the ability of one of ordinary skill in the art.

The levels of colorant employed in formulated inks are those levels needed to impart the desired optical density to the printed image. The amount of colorant present, such as the PR146 or PY74 prescribed herein, is typically in the range of about 0.1% to about 10% by weight, and more typically in the range of about 0.5% to about 8% by weight, based on the total weight of the ink.

Additives, when present, generally comprise less than about 15% by weight, based on the total weight of the ink. Surfactants, when added, are generally in the range of about 0.1% to about 3% by weight based on the total weight of the ink. Polymers can be added as needed, but will generally be less than about 12% by weight based on the total weight of the ink.

### Ink Properties

Jet velocity, separation length of the droplets, drop size and stream stability are greatly affected by the surface tension and the viscosity of the ink. Pigmented ink jet inks typically have a surface tension in the range of about 20 dyne/cm to about 70 dyne/cm at 25° C. Viscosity can be as high as 30 cP at 25° C., but is typically somewhat lower. The ink has physical properties compatible with a wide range of ejecting conditions, i.e., driving frequency of the piezo element or ejection conditions for a thermal head for either a drop-on-demand device or a continuous device, and the shape and size of the nozzle. The inks should have excellent storage stability for long periods so as not to clog to a significant extent in an ink jet apparatus. Furthermore, the ink should not corrode parts of the ink jet printing device it comes in contact with, and it should be essentially odorless and non-toxic.

Although not restricted to any particular viscosity range or printhead, the inventive ink set is particularly suited to lower viscosity applications such as those required by thermal printheads. Thus the viscosity of the inventive inks at 25° C. can be less than about 7 cP, typically less than about 5 cP, and more typically than about 3.5 cP. Thermal inkjet actuators rely on instantaneous heating/bubble formation to eject ink drops and this mechanism of drop formation generally requires inks of lower viscosity.

Preferred pH for the ink is in the range of from about 6 to about 8.

### Ink Set

The term “ink set” refers to all the individual inks or other fluids an inkjet printer is equipped to jet. Ink sets typically comprise at least three differently colored inks. For example, a cyan (C), magenta (M) and yellow (Y) ink forms a CMY ink set. More typically, an ink set includes at least four differently colored inks, for example, by adding a black (K) ink to the CMY ink set to form a CMYK ink set. Thus, an ink set comprising the required magenta pigmented ink of the present invention will also commonly comprise a cyan and yellow ink or a cyan, yellow and black ink.

In addition to the typical CMY or CMYK inks, an ink set may further comprise one or more “gamut-expanding” inks, including differently colored inks such as an orange ink, a green ink, a red ink and/or a blue ink, and combinations of full strength and light strength inks such as light cyan and light magenta. Such other inks are, in a general sense, known to one skilled in the art.

The other inks in the ink set are also typically aqueous inks and are subject to the same formulation considerations as those herein before described. The other inks in the ink set may be pigment based or dye based. Typically the other inks are pigment based. Examples of pigments with coloristic properties useful in inkjet inks, in addition to those already mentioned, include: cyan pigment from Pigment Blue 15:3 and Pigment Blue 15:4; magenta pigment from Pigment Red 202; yellow pigments from Pigment Yellow 14, Pigment Yellow 95, Pigment Yellow 110, Pigment Yellow 114, Pigment Yellow 128 and Pigment Yellow 155; red pigments from Pigment Orange 5, Pigment Orange 34, Pigment Orange 43, Pigment Orange 62, Pigment Red 17, Pigment Red 49:2, Pigment Red 112, Pigment Red 149, Pigment Red 177, Pigment Red 178, Pigment Red 188, Pigment Red 255 and Pigment Red 264; green pigments from Pigment Green 1, Pigment Green 2, Pigment Green 7 and Pigment Green 36; blue pigments from Pigment Blue 60, Pigment Violet 3, Pigment Violet 19, Pigment Violet 23, Pigment Violet 32, Pigment Violet 36 and Pigment Violet 38; and black pigment from carbon black.

In one embodiment of the present invention, an ink set comprises the prescribed magenta ink and a fixer ink. Typically, the PR146 is dispersed with an anionic polymeric dispersant and the fixer comprises a cationic fixing agent.

### Fixer Ink

A fixer ink (or fixer) is an ink that is jetted over and/or under a colored ink to enhance the coloristic or durability properties. Generally, a fixer for pigments is designed to increase chroma and/or optical density. However, fixers may also have other additional beneficial effects.

Fixer ink comprises an aqueous vehicle and one or more fixing agent(s). Fixing agent(s) in general are substantially colorless. Fixing agents are most commonly designed to operate by electrostatic interaction with the colorant. Thus, an anionic dye or pigment dispersion is treated with a cationic fixing agent thereby immobilizing or “fixing” the colorant. This process is sometimes referred to in the art as “insolubilizing”, “precipitating” or “crashing” the colorant. Other mechanisms of fixation are also possible such as fixing agent(s) that immobilize colorant by causing a sudden and dramatic pH or viscosity change. In some cases a combination of mechanisms may be operative.

A cationic polymer may be employed as a fixing agent. The cationic polymer can be a water-soluble polymer, a cationic hydrosol or dispersed polymer, or an emulsion polymer dispersed in the liquid composition vehicle. Examples of water-soluble cationic polymers are polydiallyldimethyl ammonium chlorides and protonated forms of polyamines including polyethyleneimine, polyvinylpyridine, polyvinylamine and polyallylamine. The number average molecular weight (Mn) of soluble polymer fixing agents is between about 1,000 and 10,000 g/mol.

The cationic polymer may also be a copolymer of different cationic monomers or a copolymer of cationic and nonionic monomers. The copolymer can be random or structured, linear, grafted or branched.

Examples of polymerizable monomers that can be incorporated into water-soluble homo-polymers or co-polymers include acrylic esters having tertiary amines such as N,N-dimethylaminoethyl methacrylate, N,N-dimethylaminoethyl-acrylate, N,N-dimethylaminopropyl-methacrylate, N,N-dimethylaminopropyl-acrylate; and acrylamides having tertiary amines such as N,N-dimethylaminopropyl acrylamide, N,N-dimethylaminoethyl acrylamide, N,N-dimethylaminopropyl methacrylamide, N,N-dimethylaminoethyl methacrylamide and the like. When monomers having tertiary amines are used, they are neutralized with an acid and dissolved in water.

Cationic emulsion or dispersed polymers may be employed as a fixing agent. These can be made from polymerizable monomers such as the ones mentioned in the preceding paragraph.

Multivalent metal cations may be employed as a fixing agent. “Multivalent” indicates an oxidation state of two or more. The multivalent cations are typically soluble in the aqueous vehicle, and typically exist in a substantially ionized state. The multivalent cations should be in a form where they are free and available to interact with the colorant(s) being fixed. Multivalent cations include, but are not limited to, multivalent cations of elements Ca, Mg, Zn, Cu and Al. The effective amounts needed in a particular situation may vary, and consequently some adjustment is generally necessary.

Other examples of cationic substances which may be useful as fixing agents include primary, secondary or tertiary amine salt compounds, such as hydrochloride or acetate of lauryl amine or stearyl amine; a phosphonium salt; a sulfonium salt; an ammonium salt, such as quaternary ammonium salts lauryltrimethylammonium chloride or benzyltributylammonium chloride; a pyridium salt compound such as cetylpyridinium chloride or cetylpyridinium bromide; and an arsonium salt. The ammonium, phosphonium and arsonium salts may be mono-, di-, tri or tetra-substituted or mixtures thereof.

The fixing fluid will typically be deposited on the substrate before the ink (underprinted), and typically only in areas subsequently printed with colored ink(s). The area covered by the fixer (area fill) need not, however, fill the entire area to be printed with a colored ink. Also, the color ink needs not fall entirely on top of the deposited fixer. To minimize the liquid load on the substrate, the fixer ink(s) are typically formulated to be effective at volumes equal to or less than the volume of the colored ink being fixed. The need for only a small amount of fixer ink(s) to enhance the coloristic or durability properties of the images printed is highly advantageous as this decreases the liquid load the substrate must handle. High liquid load can result in cockle or curl of paper substrate.

The following examples illustrate the invention without, however, being limited thereto.

### EXAMPLES

A cross reference of pigment trade names and the corresponding Color Index names is provided in Table A below.

TABLE A

| Pigment Trade Name | Color Index Name | Vendor/Mfg |
|---|---|---|
| Permanent Carmine FBB02 | PR146 | Clariant* |
| Magenta E-02 | PR122 | Clariant* |
| Yellow 5GX-03 | PY74 | Clariant* |

*commercially available from Clariant Pigments and Additives, Coventry, RI, USA.

### Polymer 1

Polymer 1 is a random copolymer of benzylmethacrylate (BzMA) and methacrylic acid (MAA) with a weight ratio of 90/10 BzMA/MAA. The number average molecular weight (Mn) is about 5,000 g/mol. It was prepared according to the disclosure in U.S. Patent Publication No. 2005/0090599 and recovered as a concentrated solution in 2-pyrrolidone solvent.

### Dispersions

The aqueous dispersions listed in Table B below were prepared using Polymer 1 as the dispersant. The pigment to dispersant weight ratio is 2.5:1. Ingredients were first mixed in a High Speed Disperser (HSD) and then milled in a media mill using YTZ® media. The milled dispersion was purified by an ultra filtration to remove the solvent introduced with the dispersant and provide a final dispersion in water with 12% of pigment. Proxel™ GXL, in a quantity of about 0.2% by weight of the total dispersion, was added to inhibit microbial growth.

Dispersion A2 was similar to Dispersion A1 except its smaller particle size.

TABLE B

| | Color Index | | D50 | D95 |
|---|---|---|---|---|
| Dispersion | Name | Pigment | (nm) | (nm) |
| A1 | PR146 | Permanent | 143 | 307 |
| | | Carmine FBB02 | | |
| A2 | PR146 | Permanent | 115 | 230 |
| | | Carmine FBB02 | | |
| B | PR122 | Magenta E-02 | 104 | 192 |
| C | PY74 | Yellow 5GX-03 | — | — |

### Color Measurement

Optical density, chroma and hue were measured using a Greytag-Macbeth Spectrolino spectrometer. The hue (h_{ab}) and chroma (C*_{ab}) values are based on CIELAB colorspace L*, a* and b* terms according to the following equation:

h_{ab}=tan⁻¹(b*/a*)

wherein the angle is adjusted for the appropriate quadrant and C*_{ab}=(a^{*2}+b^{*2})^{1/2}. The measurements and definitions are well known in the art, see: for example, ASTM Standard E308, published by American Society for Testing and Materials (ASTM) International, and Principles of Color Technology, Billmeyer and Saltzman, 3rd Ed., Roy Berns editor, John Wiley & Sons, Inc. (2000).

### Example 1

Inks 1A-1D were prepared using Dispersions A-C, and other ingredients according to Table 1A. Ink 1A is a comparative ink with PR122. Ink 1B, an ink of the present invention, is a magenta ink with PR146. Ink 1C is a comparative ink also with PR146, but having a smaller particle size. Ink 1D, an ink of the present invention, is a yellow ink with PY74.

TABLE 1A

| | Ink 1A | | Ink 1C | Ink 1D |
|---|---|---|---|---|
| Ingredients | (Comparative) | Ink 1B | (Comparative) | (Yellow) |
| Dispersion B* | 3.0 | — | — | — |
| Dispersion A1* | — | 3.0 | — | — |
| Dispersion A2* | — | — | 3.0 | — |
| Dispersion C* | — | — | — | 4.0 |
| 2-Pyrrolidone* | 8.0 | 8.0 | 8.0 | 8.0 |
| 1,2-hexanediol* | 0.5 | 0.5 | 0.5 | 0.5 |
| Glycerol* | 2.0 | 2.0 | 2.0 | 2.0 |
| Glycereth-26* | 6.0 | 6.0 | 6.0 | 6.0 |
| Ethylene glycol* | 2.0 | 2.0 | 2.0 | 2.0 |
| Surfynol 465* | 0.3 | 0.3 | 0.3 | 0.3 |
| Water Added | Balance | Balance | Balance | Balance |
| | to 100% | to 100% | to 100% | to 100% |

*as % by weight based on total weight of ink

Inks were loaded into and printed from a Canon i560 printer. Substrates were Xerox 4200 paper, Hewlett Packard Multipurpose paper (“HP Multipurpose”) and Hewlett Packard Bright White paper (“HP Bright White”). In addition to each ink printed separately, a secondary red color was printed by the combination of yellow ink 1D and magenta ink 1A or 1B in a 1:1 ratio.

The print properties are summarized in Table 1B. Results showed that the inventive magenta ink 1B with the larger particle size PR146 gives more favorable OD and chroma than the comparative magenta ink 1C with the smaller particle size PR146. The results also showed that the inventive magenta ink 1B in combination with yellow ink 1D gives a red with higher OD and chroma than the comparative magenta ink 1A in combination with the same yellow ink.

TABLE 1B

| | | | | | |
|---|---|---|---|---|---|
| | | | | Ink 1A + | Ink 1B + |
| Properties | Ink 1A | Ink 1B | Ink 1C | Ink 1D | Ink 1D |

Optical Density

| | | | | | |
|---|---|---|---|---|---|
| Xerox 4200 | 0.94 | 1.08 | 1.08 | 1.10 | 1.10 |
| HP Multipurpose | 1.07 | 1.28 | 1.21 | 1.16 | 1.24 |
| HP Bright White | 1.05 | 1.35 | 1.19 | 1.12 | 1.21 |

Chroma (Chroma unit)

| | | | | | |
|---|---|---|---|---|---|
| Xerox 4200 | 67 | 69 | 63 | 63 | 63 |
| HP Multipurpose | 74 | 74 | 73 | 70 | 74 |
| HP Bright White | 73 | 76 | 73 | 67 | 72 |

Hue (degree)

| | | | | | |
|---|---|---|---|---|---|
| Xerox 4200 | 343 | 6 | 5 | 42 | 33 |
| HP Multipurpose | 343 | 11 | 7 | 42 | 34 |
| HP Bright White | 342 | 10 | 6 | 42 | 34 |

### Example 2

Magenta inks 2A and 2B, similar to inks 1A and 1B in the previous example but with lower pigment content, were prepared using Dispersions B and A1, and other ingredients according to Table 2A. A fixer ink (Fixer A) was also prepared.

TABLE 2A

| | Ink 2A | | |
|---|---|---|---|
| Ingredients | (Comparative) | Ink 2B | Fixer A |
| Dispersion B* | 2.0 | — | — |
| Dispersion A1* | — | 2.0 | — |
| Calcium Nitrate* | — | — | 3.5 |
| Tetraethylene glycol* | — | — | 6.0 |
| 1,5-pentanediol* | — | — | 10.0 |
| 2-Pyrrolidone* | 8.0 | 8.0 | — |
| 1,2-hexanediol* | 0.5 | 0.5 | — |
| Glycerol* | 2.0 | 2.0 | — |
| Glycereth-26* | 6.0 | 6.0 | — |
| Ethylene glycol* | 2.0 | 2.0 | — |
| Surfynol 465* | 0.3 | 0.3 | — |
| Water Added | Balance to | Balance to | Balance to |
| | 100% | 100% | 100% |

*as % by weight based on total weight of ink

Magenta inks 2A and 2B were printed over fixer A using various volumes of ink and fixer. The fixer and ink were printed from different channels of the same printhead of a Canon i950 printer, in a single pass, onto Xerox 4200 paper. The inks were also printed without the fixer. Print results, summarized in Table 2B below, showed that the inventive ink 2B, with PR146, receives a larger boost in optical density and chroma from the fixer than the comparative ink 2A with PR122.

TABLE 2B

| | | |
|---|---|---|
| | | Chroma (Chroma |
| Volume (g/m2) | OD | unit) |

| Ink | Fixer A | Ink 2A | Ink 2B | Ink 2A | Ink 2B |
|---|---|---|---|---|---|
| 7.0 | None | 0.65 | 0.73 | 56 | 56 |
| 7.0 | 2.3 | 0.75 | 0.90 | 62 | 64 |
| 11.0 | None | 0.76 | 0.82 | 59 | 59 |
| 11.0 | 3.7 | 1.04 | 1.22 | 71 | 73 |
| 17.0 | None | 1.06 | 0.84 | 69 | 58 |
| 17.0 | 6.7 | 1.20 | 1.47 | 73 | 78 |

What is claimed is:

1. An inkjet ink set comprising a first ink and a second ink, wherein
said first ink comprises an aqueous vehicle and particles of Pigment Red 146 (PR146) dispersed in the aqueous vehicle, wherein the particles of PR146 collectively comprise a distribution of particle sizes, and wherein the volume median particle diameter (D50) of the distribution of particle sizes for PR146 is greater than 120 nm as measured by laser diffraction techniques, and
said second ink comprises an aqueous vehicle and Pigment Yellow 74 or a fixing agent capable of fixing the first ink.

2. The inkjet ink set of claim 1, wherein the D50 of the distribution of particle sizes for PR146 is greater than 125 nm and the volume particle diameter of the 95^{th} percentile (D95) of the distribution of particle sizes for PR146 is less than 375 nm.

3. The ink set of claim 2, wherein the D50 of the distribution of particle sizes for PR146 is in the range of 130 to 170 nm, and the D95 of the distribution of particle sizes for PR146 is less than 325 nm.

4. The inkjet ink set of claim 1, wherein the second ink comprises Pigment Yellow 74.

5. The inkjet ink set of claim 1, wherein the second ink comprises a fixing agent capable of fixing the first ink.

6. The inkjet ink set of claim 5, wherein the particles of Pigment Red 146 in the first ink are dispersed in the aqueous vehicle with an anionic polymeric dispersant.

7. The inkjet ink set of claim 1, wherein said first and second inks each individually have a surface tension in the range of about 20 mN·m⁻¹ to about 50 mN·m⁻¹ at 25° C., and a viscosity in the range of about 1 mPa·s to about 20 mPa·s at 25° C.
